(19) United States
(12) Patent Application Publication
(10) Pub. No.: US 2014/0306537 A1
(43) Pub. Date: Oct. 16, 2014

(54) Power Management System and Method for Optimizing Fuel Consumption

(71) Applicant: Chemmangot Velayudhan Nayar, Willetton (AU)

(72) Inventor: Chemmangot Velayudhan Nayar, Willetton (AU)

(73) Assignee: Regen Technologies Pty Ltd, Willetton (AU)

(21) Appl. No.: 14/238,844

(22) PCT Filed: Aug. 19, 2011
(86) PCT No.: PCT/AU2011/001068

§ 371 Date: Apr. 23, 2014

(51) Int. Cl. H02J 7/35

(52) U.S. Cl. CPC H02J 7/35
USPC 307/64

(57) ABSTRACT

The present disclosure describes embodiments of an efficient power management system and method for fuel efficiency. The power management system comprises an energy storage unit, at least one renewable energy resource, a controller and an engine. The engine is configured to operate at varying speeds to provide mechanical energy to a variable speed DC generator to generate power to charge up the energy storage unit. The speed of the engine is varied in response to a speed reference determined by the controller.

### TECHNICAL FIELD

The present disclosure relates to efficient power management system and method. Power management system and method of this disclosure are tailored to achieve fuel efficiency. This is facilitated by the use of a variable speed DC generator coupled with at least one renewable energy resource.

### BACKGROUND

Power generation is achieved by use of generators which supply alternating current (AC) power. In most configurations of power generation systems, two or more generators are used to meet the power demand. The AC power is converted to direct current (DC) power by way of a bank of rectifiers. Additionally, these rectifiers charge a bank of energy storage units that is used to bridge the switching from one generator to another generator so as to ensure a smooth supply of energy. The generators used in power generation systems are varied based upon the fuel used to operate the generators. Some examples of generators include nuclear powered generators, diesel powered generators and those dependent upon fossil fuels as the energy source.

In many applications of electrical generator systems, steady state load demand is usually low relative to generator power capacity. However, generators for used in power generation are selected based upon their peak performance and this leads to an ‘over-sized’ generator most of the time. This leads to excessive usage of fuel which may have adverse effects on the environment. Although there are solar energy based generators which utilizes solar energy to generate power, these are not reliable as the lack of adequate solar energy can result in the generators operating at a lower efficiency.

Therefore, there is a need for power generation systems which are reliable and at the same time, reduce adverse environmental effects.

### SUMMARY

One of the objects of certain exemplary aspects of the present disclosure is to address the aforementioned exemplary problems and/or to overcome the exemplary deficiencies commonly associated with power generation systems as described herein. Accordingly, for example, provided and described herein are certain exemplary embodiments of exemplary power management systems and methods for optimizing fuel consumption.

According to one aspect of this disclosure, there is provided a power management system for optimizing fuel consumption. The power management system comprises an energy storage unit configured to supply power to a load, at least one renewable energy resource configured to generate power to charge up the energy storage unit, a controller configured to generate a speed reference, the speed reference dependent upon at least one of charge status of the energy storage unit, the load and power generated by the at least one renewable energy resource and an engine configured to operate at varying speeds to provide mechanical energy to a variable speed DC generator to generate power to charge up the energy storage unit. The speed of the engine and consequently the power generated by the variable speed DC generator is being varied in response to the speed reference determined by the control unit.

In another aspect, there is disclosed a method of optimizing fuel consumption of a power management system. The power management system comprises generating a speed reference, the speed reference is generated based upon at least one of charge status of an energy storage unit, a load and power generated by at least one renewable energy resource and varying speed of an engine. The speed of the engine is varied in response to the speed reference for optimizing fuel consumption.

### BRIEF DESCRIPTION OF THE DRAWINGS

Embodiments of the disclosure are described hereinafter with reference to the following drawings, in which:

FIG. 1 shows a power generation system of this disclosure comprising a variable speed DC generator, at least one renewable energy source, a controller, a power combiner, an energy storage unit a load and a network of DC bus.

FIG. 2 shows a block diagram of a variable speed DC generator which includes an engine, an alternator, a governor, an engine monitoring system and an auxiliary battery.

FIG. 3 is a flow diagram showing a process of efficient power generation comprising the steps of setting parameters on the control panel, generating a speed reference, providing the speed reference to the governor, adjusting speed of engine, charging the energy storage unit and delivering power to the load.

### DETAILED DESCRIPTION

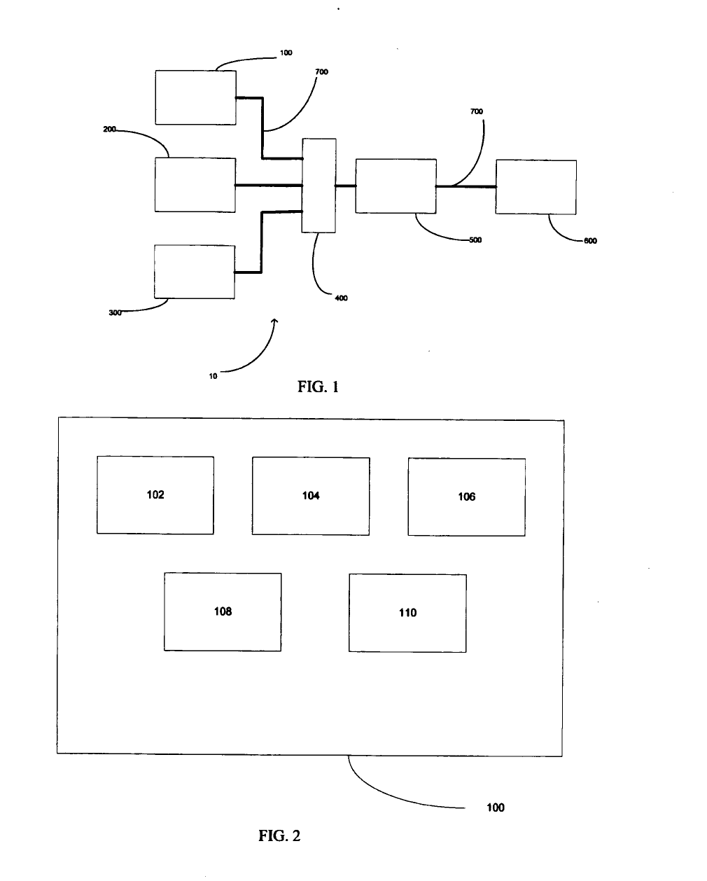

Representative embodiments of the disclosure for addressing one or more of the foregoing problems associated with conventional power management systems are described hereafter with reference to FIGS. 1 to 3. For purposes of brevity and clarity, the description herein is primarily directed to systems, devices, and techniques for efficient power management. This, however, does not preclude various embodiments of the disclosure from other applications where fundamental principles prevalent among the various embodiments of the disclosure such as operational, functional, or performance characteristics are required. In the description that follows, like or analogous reference numerals indicate like or analogous elements.

Embodiments of this disclosure relate to power management systems and/or methods for use in conjunction with electrical grids. In particular, the power management systems and/or methods can be utilised in a telecommunication base station, remote mining camp sites or one or more pumpjacks. The power management system comprises a variable speed DC generator, a controller, at least renewable energy source, a power combiner, an energy storage unit and a load. In many embodiments, the variable speed DC generator comprises an engine, an alternator, a governor, an engine monitoring system and a controller. The engine can include a diesel engine, a combustion engine, a gas engine, a reciprocating engine or any other engine suitable for use with the variable speed DC generator.

By utilizing renewable energy sources such as solar arrays, wind turbines, hydrogenerators and biomass, the variable speed DC generator can be adapted to adjust the speed of the engine to operate at an optimal level. Varying or adjusting the speed of the engine is initiated by a speed reference which is provided to the governor to enable the engine to operate at an optimal speed for fuel optimization/efficiency. In some embodiments, the fuel utilized is in the form of diesel fuel or any other combustible fuel and in such embodiments, fuel optimization/efficiency can minimize adverse environmental effects by reducing the emission of carbon dioxide by combustion. The speed reference is calculated or generated by the controller based upon at least one of charge status of the energy storage unit, the load and power generated by the at least one renewable energy resource. The engine described in this disclosure is started or stopped with the aid of an auxiliary battery.

The variable speed DC generator and the at least one renewable sources such as the solar array, the wind turbine, the hydrogenerator and biomass are configurable to generate power to charge up the energy storage unit. Depending upon lighting and/or weather conditions, the solar array and/or the wind turbine can operate to generate power to charge up the energy storage unit and this can alleviate the operation of the variable speed DC generator, resulting in fuel optimization/efficiency. Conversely, when there is insufficient light and/or wind, the solar array and/or the wind turbine may not be operable and the charging of the energy storage unit is performed by the variable speed DC generator.

The controller of the variable speed DC includes a control panel which is adapted to receive instructions from a user of the power management system. By having a control panel to receive instructions from a user, fuel optimization/efficiency can be further controlled by user as it provides a user the flexibility to enter in parameters to control rate of charging the energy storage unit.

This disclosure describes a method for efficient power management. The method comprises setting parameters on the control panel, calculating the speed reference, providing the speed reference to the governor, adjusting the speed of the engine, charging the energy storage unit and delivering power to the load. By calculating the speed reference, the speed of the engine can be adjusted and/or varied to achieve optimal speed for fuel optimization/efficiency. Calculating the speed reference takes into consideration at least one of charge status of the energy storage unit, the load and power generated by the at least one renewable energy source. Under favourable weather conditions, for instance, in the presence of light and/or wind, the solar array and/or the wind turbine can be operable to charge the energy storage unit. This allows the variable speed DC generator to operate at a lower operating level and achieving fuel optimization/efficiency.

Although the description of this disclosure is directed to use of renewable sources such as the solar array, the wind turbine, the hydrogenerator and biomass for fuel optimization/efficiency, it should be understood by a person of ordinary skill in the art that other types of renewable sources can be used. Any alterations and further modifications in the following described embodiments, and any further applications of the principles of the invention as described herein are contemplated as would normally occur to one of ordinary skill in the art to which the disclosure relates.

FIG. 1 shows a power generation system 10 according to embodiments of this disclosure. The power generation system 10 comprises a variable speed DC generator 100, at least one renewable energy source 200, a controller 300, a power combiner 400, an energy storage unit 500, a load 600 and a network of DC bus 700. The at least one renewable energy source 200 includes a wind turbine, a solar array including a solar panel, a photovoltaic module, a photovoltaic panel and an assembly of solar cells, a hydrogenerator and biomass. Depending upon embodiment details, the at least one renewable energy source 200 can include more than one renewable energy source 200 which are identical. For instance, the power generation system 10 can comprise two wind turbines.

In some embodiments, the controller 300 is a constituent of the variable speed DC generator 100. That is to say, the controller 300 is an integrated part of the variable speed DC generator 100. Depending upon embodiment details and/or user requirements, the power generation system 10 can comprise more than one variable speed DC generators 100, a plurality of controllers 300, more than one power combiner 400, a plurality of energy storage units 500 and a plurality of loads 600. The variable speed DC generator 100, the at least one renewable energy source 200, the controller 300, the power combiner 400 and the energy storage unit 500 can be known as a hybrid dynamic energy balancer. Although embodiments of this disclosure relate to the use of a variable speed DC generator 100, it should be understood by a person of ordinary skill in the art that other generators can also be used. The load 600 can be a telecommunication base station, remote mining camp sites or one or more pumpjacks.

The power combiner 400 includes a plurality of input ports and a plurality of output ports. By way of the network of DC bus 700, the variable speed DC generator 100, the at least one renewable source 200, the controller 300 are electrically coupled to each of the plurality of input ports of the power combiner 400. In embodiments where the controller 300 is a constituent of the variable speed DC generator 100, the controller 300 is electrically coupled to the input port of the power combiner 400 via the variable speed DC generator 100. Analogously, the network of DC bus 700 electrically couples the energy storage unit 500 and the load 600 to each of the plurality of output ports.

In such power systems, one or more power conditioners can be utilized to facilitate delivery of power from the variable speed DC generator 100 and/or the at least one renewable energy source 200 to the power combiner 400. For instance, a first power conditioner can be coupled between the variable speed DC generator 100 and the power combiner 400 and analogously, a second power conditioner can be coupled between the at least one renewable energy source 200 and the power combiner 500.

The power generation system 10 can be a constituent of a power grid or a stand-alone system to provide electrical energy. While the variable speed DC generator 100 is the main source of power to charge up the energy storage unit 500, the at least one renewable energy source 200 can function to work collaboratively with the variable speed DC generator 100 to provide power. When in operation, the at least one renewable energy source 200 provides some benefits to the power generation system 10 as the at least one renewable energy source 200 do not consume any fuel when generating power to charge up the energy storage unit 500, unlike the variable speed DC generator 100, which consumes fuel. The type of fuel consumed by the variable speed DC generator 100 is dependent upon type of engine that is used by the variable speed DC generator 100. For instance, the variable speed DC generator 100 can include a diesel engine and if so, diesel fuel is consumed.

Depending on the weather and/or lighting conditions, the power generation system 10 of this disclosure optimizes the overall fuel consumption of the variable speed DC generator 100 by optimising the use of the at least one renewable energy source 200 whenever possible. For instance, when the wind conditions are favourable to operate the at least one renewable energy source 200 such as a wind turbine, the variable speed DC generator 100 can decrease its output power to charge the energy storage unit 500, hence enabling the variable speed DC generator 100 to lower its fuel consumption and/or achieving fuel optimization/efficiency. In embodiments where diesel fuel or any other combustible fuel is consumed, fuel optimization/efficiency can minimize adverse environmental effects by reducing the emission of carbon dioxide by combustion. Correspondingly, when the lighting conditions are favourable, the at least one renewable energy source 200 such as a solar array can operate to charge the energy storage unit 500. Under some weather conditions such as when there is the availability of wind and solar energy (i.e sunlight), the wind turbine and the solar array, if available, can function collaboratively to charge the energy storage unit 500. This results in the variable speed DC generator 100 consuming less fuel as the output power generated by the variable speed DC generator 100 is reduced. Conversely, when the wind conditions and/or lighting conditions are not favourable, the wind turbine and/or the solar array are in a ‘shut down’ mode. This results in the variable speed DC generator 100 operating independently to generate power for charging the energy storage unit 500. Relative to the earlier scenario where the output power generated by the variable speed DC generator 100 is reduced, more fuel is consumed by the variable speed DC generator 100 when it is operating independently.

The power generation system 10 of this disclosure optimises fuel consumption by enabling variation to the speed of the variable speed DC generator 100. This will be discussed further below. Unlike conventional power systems, the power generation system 10 of this disclosure requires just one variable DC generator 100. This result in lower fuel consumption and overall power efficiency. Further, as compared to other power generation systems, the power generation system 10 of this disclosure does not require any rectifier system, resulting in improved space efficiency.

### Variable Speed DC Generator

FIG. 2 shows a block diagram of a variable speed DC generator 100 according to some embodiments of this disclosure. The variable speed DC generator 100 includes an engine 102, an alternator 104, a governor 106, an engine monitoring system 108 and an auxiliary battery 110 for starting and stopping the diesel engine 102. As discussed earlier, the variable DC generator 100 can include the controller 300.

The variable speed DC generator 100 is configured to generate power to charge up the energy storage unit 500. In many embodiments, the amount of power generated by the variable speed DC generator 100 is provided for by the engine 102. The engine 102 can include a diesel engine, a combustion engine, a gas engine, a reciprocating engine or any other engine suitable for use with the variable speed DC generator 100. The engine 102 is configured to operate at varying speeds to provide rotational or mechanical energy to the variable speed DC generator 100. Speed of the engine 102 is determined and/or varied in response to a speed reference which, is provided to the governor 106. The governor 106 is a speed sensitive component of the variable speed DC generator 100 which limits the speed of the engine 102 by controlling the rate of fuel delivery. This is facilitated by the governor 106 providing the engine 102 with feedback mechanism to change speed when required so as to maintain a desired speed. In many embodiments, the feedback mechanism of the governor 106 includes a magnetic pickup unit which provides sinusoidal feedback.

The rotational operating speed of the engine 102 and correspondingly rotational speed of the variable speed DC generator 100 varies over a selected operating range in response to the speed reference. The speed reference is generated by the controller 300 and the speed reference is based or dependent upon at least one of charge status of the energy storage unit 500, the load 600 and power generated by the at least one renewable energy resource 200. The controller 300 will be described in greater detail later. The charge status of the energy storage unit 500 includes at least one of amount of charge in the energy storage unit 500 and rate of accumulation of charges of the energy storage unit 500. Depending upon the output load 500 such as the availability of a telecommunication base station and/or remote mining camp site, the variable speed DC generator 100 can vary the speed of the engine 102 to achieve optimal fuel efficiency. The power generated by the at least one renewable energy resource 200 is a factor to determine the speed reference in that if sufficient power is generated by the at least one renewable energy source 200 to charge up the energy storage unit 500, the speed reference will enable the variable speed DC generator 100, in particular the engine 102 to operate at a lower speed and thus consume less fuel. In an exemplary operation, an input of 0 volts from the controller 200 will generate a speed reference which corresponds to 800 revolutions per minute of the engine 102 and an input of 5 volts from the controller 200 will generate a speed reference which corresponds to the engine 102 operating at 1300 revolutions per minute. By providing the speed reference to the engine 102, fuel optimization/efficiency is achieved as the speed reference facilitates the engine 102 to operate at a speed for fuel optimization/efficiency. As understood by a person of ordinary skill in the art, the alternator 104 is an electromechanical device that converts mechanical energy supplied by the engine 102 to electrical energy in the form of alternating current (AC). The alternator 104 includes a 3 phase output and two auxiliary windings. The alternator 104 is externally excited by using an external DC supply.

The engine monitoring system 108 monitors status of the engine 102. By coupling to the engine 102 and the controller 300, the engine monitoring system 108 converts signals associated with the engine 102 such as temperature, water level and speed of the engine 102 to information for display to the user by way of a display screen. The engine monitoring system 108 also serves to protect the engine 102 in the event that any fault in the engine 102 is detected, a signal will be provided to the display screen for the user.

### Controller

The controller 300 is the main processing unit of the power generation system 10. The controller 300 includes a control panel configured for receiving user inputs, a battery current controller, voltage controller and a total current controller. In response to user inputs, the controller 300 executes operating logic that defines various control, management and/or regulation functions. This operating logic can take the form of dedicated hardware, for instance a hardwired state machine, programming instructions and/or a different form deemed suitable by a person of ordinary skill in the art.

The controller 300 can be a single component or a collection of operatively coupled components comprising at least one of digital circuitry, analog circuitry and hybrid circuitry. In some embodiments, the controller 300 can have one or more components remotely located relative to the others. Controller 300 can include multiple processing units arranged to operate independently, in a pipeline processing arrangement, in a parallel processing arrangement, and/or such different arrangement as deemed suitable to persons of ordinary skill in the art. In one embodiment, the controller 300 is a programmable microprocessing device of a solid-state, integrated circuit type that includes one or more processing units and memory. The controller 300 can include one or more signal conditioners, modulators, demodulators, Arithmetic Logic Units (ALUs), Central Processing Units (CPUs), limiters, oscillators, control clocks, amplifiers, signal conditioners, filters, format converters, communication ports, clamps, delay devices, memory devices, and/or different circuitry or functional components as would occur to those skilled in the art to perform the desired communications. In one configuration, the controller 300 includes a computer network interface to facilitate communications using the Controller Area Network (CAN) standard among various system components and/or components not included in the depicted system, as desired.

### Control Panel

The control panel of the controller 300 comprises a display, a set of INC/DEC buttons, an enter button, a reset button, an ESC button, a save button and a start button. Depending upon application details, the control panel allows a user to register useful parameter settings by actuating one or more of the set of INC/DEC buttons, the enter button, the reset button, the ESC button, the save button and the start button.

The power generation system 10 is operable in various modes and this can be selected by way of one or more of the buttons of the controller 300. The modes of the power generation system 10 will be discussed later. Navigating through the various modes of the variable speed DC generator 100 is carried out by actuating the set of INC/DEC buttons to select the mode of interest from the mode menu. Once the mode of interest is located, the user can activate the parameters menu of the mode by actuating the enter button. The parameters menu enables the user to register and/or change the value of the parameter by utilizing one or more of the INC/DEC buttons. Description of the parameters will be discussed in detail below. Once the value of the parameter is registered and/or changed, the user can actuate the ESC button to return to the mode menu. Once at the mode menu, the parameters are saved by actuating the save button.

The start button is actuated to initiate the mode of interest. While operating in a particular mode, the user can terminate the operation by actuating the reset button.

### Modes of Operation of the Power Generation System

The modes of the power generation system 10 include a constant current mode charging and a constant voltage mode charging. In the constant current mode charging, the terminal voltage of the energy storage unit 500 is not controlled until the energy storage unit 500 reaches an upper limit. Upon reaching the upper limit, steps are taken to ensure that the energy storage unit 500 is fully charged and also to prevent overcharging. Once the energy storage unit 500 is fully charged, the constant voltage mode is activated.

In the constant voltage mode charging, the voltage is regulated irrespective of the charging current of the energy storage unit 500. Consequently, the charging current will start decreasing gradually.

### Parameters

The power generation system 10 of this disclosure is capable of operating in several modes. In each of these modes, the user of the power generation system 10 is able to register and/or amend the parameters associated with each mode. The parameters include voltage reference, total current reference, battery current reference, speed multiplication factor and drive number.

The voltage reference parameter enables the variable speed DC generator 100 to operate at varying voltage and current levels to limit the voltage of the energy storage unit 500 within the permitted maximum voltage. For instance, if the nominal voltage rating of the energy storage unit 500 is 48 volts, the maximum permitted charging voltage is 55 volts. When a voltage reference is registered in the controller 300 by way of the control panel, the variable speed DC generator 100 will maintain the voltage output to approximately that of the voltage reference parameter.

The total current reference is the total current to be regulated within the variable speed DC generator 100 irrespective of the voltage of the variable speed DC generator 100. In many embodiments, the total current to be regulated includes the current of the energy storage unit 500 and the load 600.

The battery current reference is the maximum current at which the energy storage unit 500 has to be charged. Generally, the battery current reference can be calculated by dividing the Ampere-Hour (AH) rating of the energy storage unit 500 and dividing it by 10.

The speed multiplication factor determines the factor in which the speed of the engine 102 is increased to accommodate the load 600. In many embodiments, the speed multiplication factor is represented as a percentage (%).

### Process of Efficient Power Management

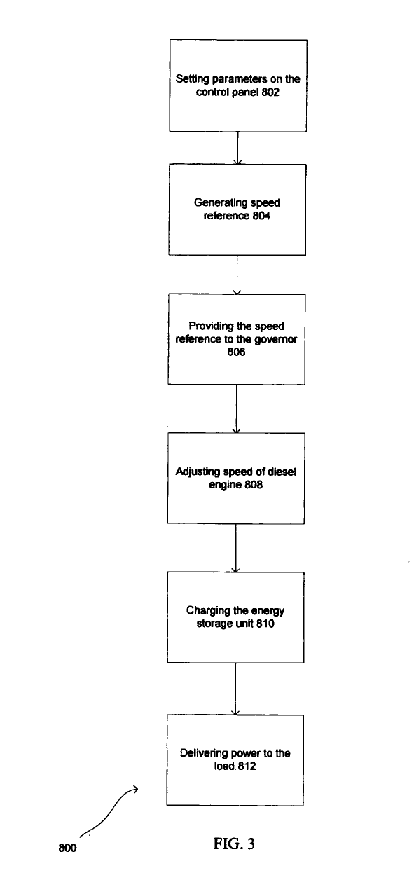

FIG. 3 is a flow diagram showing a process of efficient power generation 800 in accordance to various embodiments of this disclosure. The process of efficient power management 800 comprises the steps of setting parameters on the control panel 802, generating a speed reference 804, providing the speed reference to the governor 806, adjusting speed of engine 808, charging the energy storage unit 810 and delivering power to the load 812.

The process of efficient power management 800 described herein provides an efficient method of delivering power to the energy storage unit 500 and thereafter, to the load 600. As described previously, the load 600 can be a telecommunication base station, remote mining camp sites or one or more pumpjacks.

In a first process step, a user of the power generation system 10 registers a set of user preferences or parameter on the control panel of the controller 300. As discussed previously, the variable speed DC generator 100 is operable in different modes. For each mode, the user has the flexibility to register and/or amend a plurality of parameters from the parameters menu. Once the parameters have been set or configured, the variable speed DC generator 100, in particular, the controller 300 will proceed to generate a speed reference. This is reflected as step 804.

As discussed above, the variable speed DC generator 100 is configured to generate power to charge up the energy storage unit 500 and the amount of power generated by the variable speed DC generator 100 is provided for by the engine 102. As discussed previously, the engine 102 can include a diesel engine, a combustion engine, a gas engine, a reciprocating engine or any other engine suitable for use with the variable speed DC generator 100. The engine 102 is configured to operate at varying speeds to provide rotational or mechanical energy to the variable speed DC generator 100. Speed of the engine 102 is determined and/or varied in response to a speed reference which is provided to the governor 106. The speed reference is generated by the controller 300 and the speed reference is based or dependent upon at least one of charge status of the energy storage unit 500, the load 600 and power generated by the at least one renewable energy resource 200. The charge status of the energy storage unit 500 includes at least one of amount of charge in the energy storage unit 500 and rate of accumulation of charges of the energy storage unit 500. Depending upon the output load 500 such as the availability of a telecommunication base station and/or remote mining camp site, the variable speed DC generator 100 can vary the speed of the engine 102 to achieve optimal fuel efficiency. The power generated by the at least one renewable energy resource is a factor to determine the speed reference in that if sufficient power is generated by the at least one renewable energy source 200 to charge up the energy storage unit 500, the speed reference will enable the variable speed DC generator 100, in particular the engine 102 to operate at a lower speed and thus consume less fuel.

Upon completion of step 804, the generated speed reference is provided to the governor 106. This is shown in step 806. By providing the speed reference to the governor 106, it facilitates the governor 106 to control the rate of fuel delivery to the engine 102 and the speed of the engine 102 is adjusted accordingly. By providing the speed reference to the engine 102 via the governor 106, fuel optimization/efficiency is achieved as the speed reference facilitates the engine 102 to operate at a speed for fuel optimization/efficiency.

Varying the speed of the engine 102 is carried out in step 808. The rate of fuel delivery to the engine 102 is determined by the speed reference and controlling the rate of fuel delivery can achieve fuel optimization/efficiency of the variable speed DC generator 100. For instance, under favourable weather conditions where there is sunlight and/or wind, the at least one renewable energy source 200 such as the wind turbine and/or solar array and/or hydrogenerator and/or biomass can provide the required energy to charge the energy storage unit 500. Resultantly, this decreases the output energy provided by the variable speed DC generator 100 and thus, saving fuel and achieving fuel optimization/efficiency. Based on the above, charging the energy storage unit (step 810) is carried out by at least one of the variable speed DC generator 100 and the at least one renewable energy source 200.

In step 812, energy from the energy storage unit 500 is being delivered to the load 600.

Thus, there has been shown and discussed various embodiments of a power management system and/or method which fulfils the objectives and advantages sought thereof. Many changes, modifications, variations, and other uses and applications of the subject disclosure will, however, become apparent to those skilled in the art after considering this specification together with the accompanying figures and claims. The power management system and/or method, together with ensuing benefits are also applicable to similar equipment in unrelated industries where such technology can be implemented. All such changes, modifications, variations and other uses and applications which do not depart from the spirit and scope of the detecting device of this disclosure are deemed to be covered by embodiments of this disclosure which is limited only by the claims which follows.

In the foregoing manner, various embodiments of the disclosure are described for addressing at least one of the foregoing disadvantages. Such embodiments are intended to be encompassed by the following claims, and are not to be limited to specific forms or arrangements of parts so described and it will be apparent to one skilled in the art in view of this disclosure that numerous changes and/or modification can be made, which are also intended to be encompassed by the following claims.

1. A power management system for optimizing fuel consumption, the power management system comprising:
an energy storage unit configured to supply power to a load;
at least one renewable energy resource configured to generate power to charge up the energy storage unit;
a controller configured to generate a speed reference, the speed reference dependent upon at least one of charge status of the energy storage unit, the load and power generated by the at least one renewable energy resource; and
an engine configured to operate at varying speeds to provide mechanical energy to a variable speed DC generator to generate power to charge up the energy storage unit;
wherein the speed of the engine and consequently the power generated by the variable speed DC generator being varied in response to the speed reference determined by the control unit.

2. The power management system of claim 1, wherein the energy storage unit is electrically coupled to the load.

3. The power management system of claim 1 wherein the at least one renewable energy resource includes at least one of a wind turbine, a solar array, a hydrogenerator and biomass.

4. The power management system of claim 1 wherein the controller is a constituent of the variable speed DC generator.

5. The power management system of claim 1 wherein the controller is a single component or a collection of operatively coupled components comprising at least one of digital circuitry, analog circuitry and hybrid circuitry.

6. The power management system of claim 1 wherein the speed reference is provided to a governor.

7. The power management system of claim 1 wherein the engine includes a diesel engine, a combustion engine, a gas engine and a reciprocating engine.

8. The power management system of claim 1 further comprising:
a power combiner, the power combiner defining a plurality of input ports and a plurality of output ports, wherein the at least one renewable energy resource and the variable speed DC generator are individually coupled to at least one of the plurality of input ports and the energy storage unit is coupled to at least one of the plurality of output ports.

9. The power management system of claim 1 wherein each of the at least one renewable energy resource is coupled to a power conditioner, the power conditioner configured to facilitate delivery of power.

10. A method of optimizing fuel consumption of a power management system, the power management system comprising:
generating a speed reference, the speed reference is generated based upon at least one of charge status of an energy storage unit, a load and power generated by at least one renewable energy resource; and
varying speed of an engine, wherein the speed of the engine is varied in response to the speed reference for optimizing fuel consumption.

11. The method of claim 10 wherein the at least one renewable energy resource includes at least one of a wind turbine, a solar array, a hydrogenerator and biomass.

12. The method of claim 10 wherein the engine includes a diesel engine, a combustion engine, a gas engine and a reciprocating engine.

13. The method of claim 10 wherein the speed reference is generated by a controller.

14. The method of claim 12 wherein the controller is a single component or a collection of operatively coupled components comprising at least one of digital circuitry, analog circuitry and hybrid circuitry.

15. The method of claim 10 further comprising at least one of setting parameters on a control panel, providing the speed reference to the governor, charging the energy storage unit and delivering power to the load.
